(19) United States
(12) Patent Application Publication
(10) Pub. No.: US 2013/0290444 A1
(43) Pub. Date: Oct. 31, 2013

(54) CONNECTED MULTI-SCREEN SOCIAL MEDIA APPLICATION

(71) Applicant: MOBITV, INC., Emeryville, CA (US)

(72) Inventors: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(73) Assignee: MobiTV, Inc., Emeryville, CA (US)

(21) Appl. No.: 13/668,434

(22) Filed: Nov. 5, 2012

Related U.S. Application Data
(60) Provisional application No. 61/639,689, filed on Apr. 27, 2012.

(51) Int. Cl. H04L 12/58

(52) U.S. Cl. CPC H04L 51/32
USPC 709/206; 709/204

(57) ABSTRACT

Techniques and mechanisms are described herein for providing a connected multi-screen social media application. According to various embodiments, a selection of one of a plurality of media content items available for presentation in association with a content management account may be received. The selected media content item may be presented at a first client machine associated with the content management account. A message may be transmitted to a second client machine associated with the content management account. The message may include an instruction for displaying a social media application at the second client machine. The social media application may facilitate the exchange of user-generated content related to the selected media content item.

### CROSS-REFERENCE TO RELATED APPLICATIONS

This application claims priority to Provisional U.S. Patent Application No. 61/639,689 by Billings et al., filed Apr. 27, 2012, titled “CONNECTED MULTI-SCREEN VIDEO”, which is hereby incorporated by reference in its entirety and for all purposes.

### TECHNICAL FIELD

The present disclosure relates to connected multi-screen social media applications.

### DESCRIPTION OF RELATED ART

A variety of devices in different classes are capable of receiving and playing video content. These devices include tablets, smartphones, computer systems, game consoles, smart televisions, and other devices. The diversity of devices combined with the vast amounts of available media content has created a number of different presentation mechanisms.

However, mechanisms for providing common experiences across different device types and content types are limited. Consequently, the techniques of the present invention provide mechanisms that allow users to have improved experiences across devices and content types.

### BRIEF DESCRIPTION OF THE DRAWINGS

The disclosure may best be understood by reference to the following description taken in conjunction with the accompanying drawings, which illustrate particular embodiments.

FIGS. 1 and 2 illustrate examples of systems that can be used with various techniques and mechanisms of the present invention.

FIGS. 3-15 illustrate examples of user interfaces.

FIGS. 16 and 17 illustrate examples of techniques for communicating between various devices.

FIG. 18 illustrates one technique for conducting a connected user interface social media application lifecycle.

FIG. 19 illustrates one technique for presenting a connected user interface social media application.

FIG. 20 illustrates one technique for updating a connected user interface social media application.

FIGS. 21-22 illustrate examples of systems.

FIG. 23 illustrates examples of encoding streams.

FIG. 24 illustrates one example of an exchange used with a media delivery system.

FIG. 25 illustrates one technique for generating a media segment.

FIG. 26 illustrates one example of a system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Disclosed herein are mechanisms and techniques that may be used to provide a connected, multi-screen social media application. Users may employ various types of devices to view media content such as video and audio. The devices may be used alone or together to present the media content. The media content may be received at the devices from various sources. According to various embodiments, different devices may communicate to present a common interface across the devices. The user interface may display a social media application. The social media application may be used to share comments, ratings, or other social content related to media content items accessed via a media system.

### EXAMPLE EMBODIMENTS

According to various embodiments, a connected multi-screen system may provide a common experience across devices while allowing multi-screen interactions and navigation. Content may be organized around content entities such as shows, episodes, sports categories, genres, etc. The system includes an integrated and personalized guide along with effective search and content discovery mechanisms. Co-watching and companion information is provided to allow for social interactivity and metadata exploration.

According to various embodiments, a connected multi-screen interface is provided to allow for a common experience across devices in a way that is optimized for various device strengths. Media content is organized around media entities such as shows, programs, episodes, characters, genres, categories, etc. In particular embodiments, live television, on-demand, and personalized programming are presented together. Multi-screen interactions and navigation are provided with social interactivity, metadata exploration, show information, and reviews.

According to various embodiments, a connected multi-screen interface may be provided on two or more display screens associated with different devices. The connected interface may provide a user experience that is focused on user behaviors, not on a particular device or service. In particular embodiments, a user may employ different devices for different media-related tasks. For instance, a user may employ a television to watch a movie while using a connected tablet computer to search for additional content or browse information related to the movie.

According to various embodiments, a connected personalized content guide may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

According to various embodiments, a social media application may facilitate the exchange of user-generated content. The user-generated content may be related to media content accessed via the media system. For instance, the user-generated content may include comments, recommendations regarding content, ratings of content, and other such content. The social media application may be provided by the media system or by a third party, such as a social networking service.

According to various embodiments, a social media application may facilitate interaction via a standalone social media system provided by the connected user interface provider. Alternately, or additionally, the social media application may facilitate interaction via a third party social media system such as YouTube, Twitter, or Facebook.

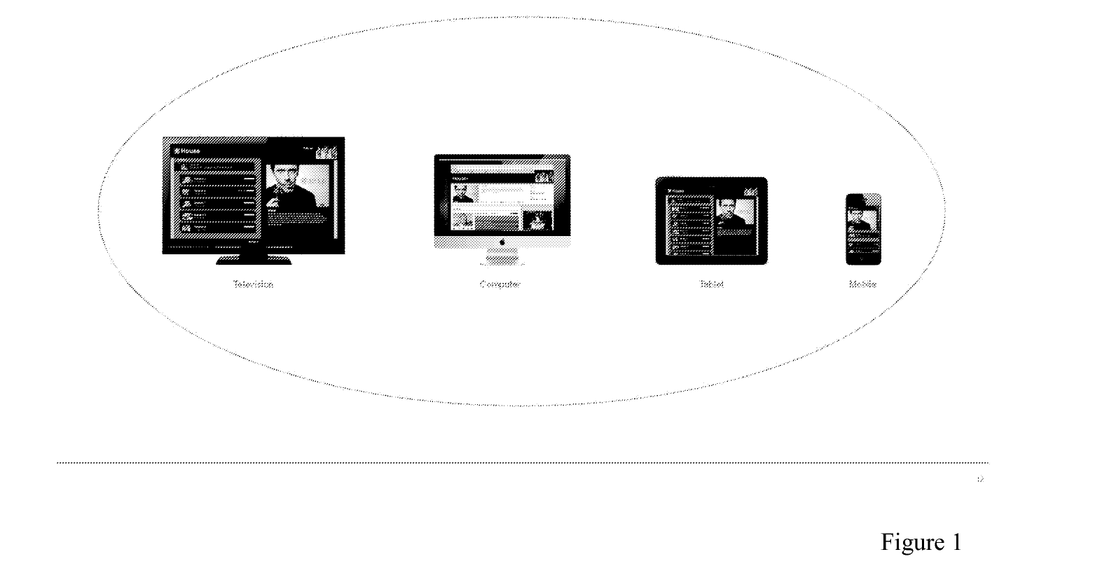

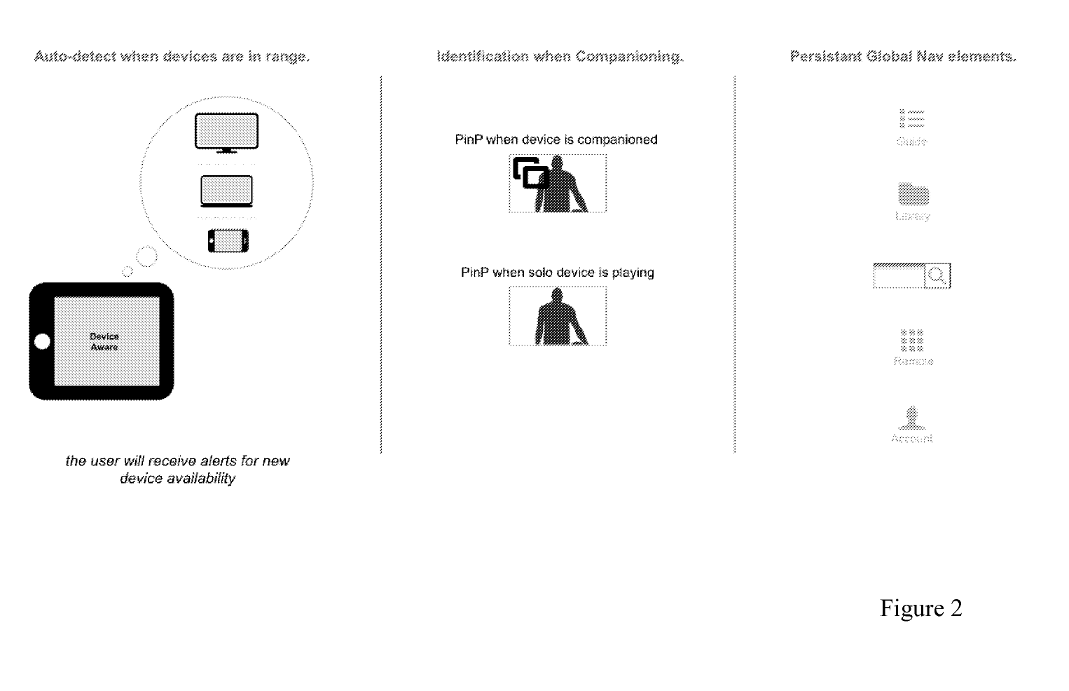

FIGS. 1 and 2 illustrate examples of systems that can be used with various techniques and mechanisms of the present invention. As shown in FIG. 1, various devices may be used to view a user interface for presenting and/or interacting with content. According to various embodiments, one or more conventional televisions, smart televisions, desktop computers, laptop computers, tablet computers, or mobile devices such as smart phones may be used to view a content-related user interface.

According to various embodiments, a user interface for presenting and/or interacting with media content may include various types of components. For instance, a user interface may include one or more media content display portions, user interface navigation portions, media content guide portions, related media content portions, media content overlay portions, web content portions, interactive application portions, or social media portions.

According to various embodiments, the media content displayed on the different devices may be of various types and/or derive from various sources. For example, media content may be received from a local storage location, a network storage location, a cable or satellite television provider, an Internet content provider, or any other source. The media content may include audio and/or video and may be television, movies, music, online videos, social media content, or any other content capable of being accessed via a digital device.

As shown in FIG. 2, devices may communicate with each other. According to various embodiments, devices may communicate directly or through another device such as a network gateway or a remote server. In some instances, communications may be initiated automatically. For example, an active device that comes within range of another device that may be used in conjunction with techniques described herein may provide an alert message or other indication of the possibility of a new connection. As another example, an active device may automatically connect with a new device within range.

According to various embodiments, a user interface may include one or more portions that are positioned on top of another portion of the user interface. Such a portion may be referred to herein as a picture in picture, a PinP, an overlaid portion, an asset overlay, or an overlay.

According to various embodiments, a user interface may include one or more navigation elements, which may include, but are not limited to: a media content guide element, a library element, a search element, a remote control element, and an account access element. These elements may be used to access various features associated with the user interface, such as a search feature or media content guide feature.

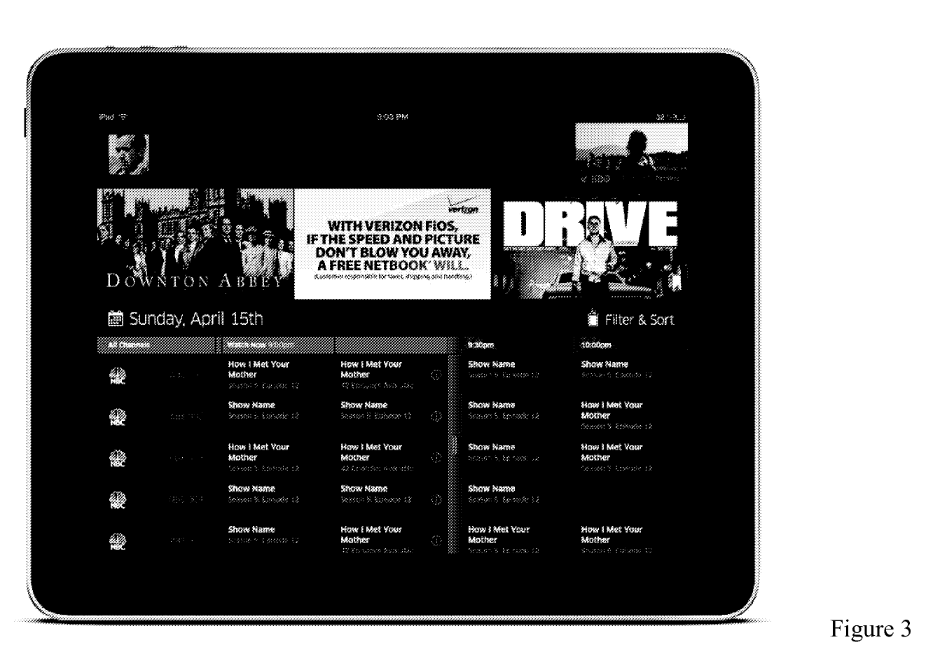

FIGS. 3-15 illustrate images of examples of user interfaces. According to various embodiments, the user interfaces shown may be presented on any of various devices. In some cases, user interfaces may appear somewhat differently on different devices. For example, different devices may have different screen display resolutions, screen display aspect ratios, and user input device capabilities. Accordingly, a user interface may be adapted to a particular type of device.

FIG. 3 illustrates an image of an example of a program guide user interface. According to various embodiments, a program guide user interface may be used to identify media content items for presentation. The program guide may include information such as a content title, a content source, a presentation time, an example video feed, and other information for each media content item. The program guide may also include other information, such as advertisements and filtering and sorting elements.

According to various embodiments, the techniques and mechanisms described herein may be used in conjunction with grid-based electronic program guides. In many grid-based electronic program guides, content is organized into “channels” that appear on one dimension of the grid and time that appears on the other dimension of the grid. In this way, the user can identify the content presented on each channel during a range of time.

According to various embodiments, the techniques and mechanisms described herein may be used in conjunction with mosaic programming guides. In mosaic programming guides, a display includes panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

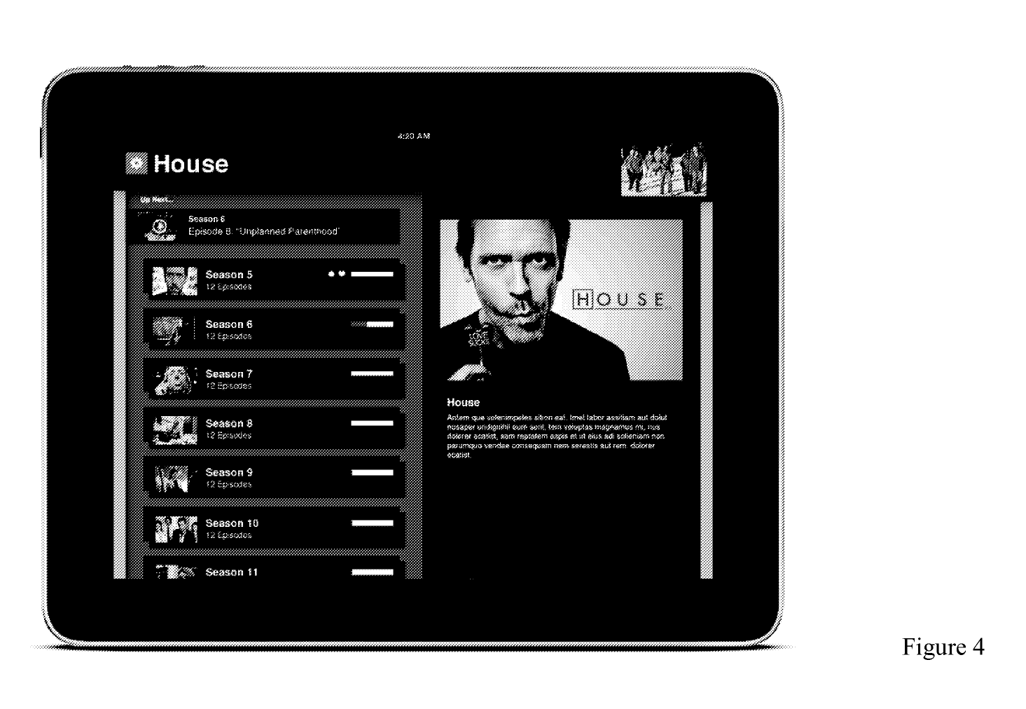

FIG. 4 illustrates an image of an example of a user interface for accessing media content items. According to various embodiments, a media content item may be a media content entity or a media content asset. A media content asset may be any discrete item of media content capable of being presented on a device. A media content entity may be any category, classification, container, or other data object capable of containing one or more media content assets or other media content entities. For instance, in FIG. 4, the television show “House” is a media content entity, while an individual episode of the television show “House” is a media content asset.

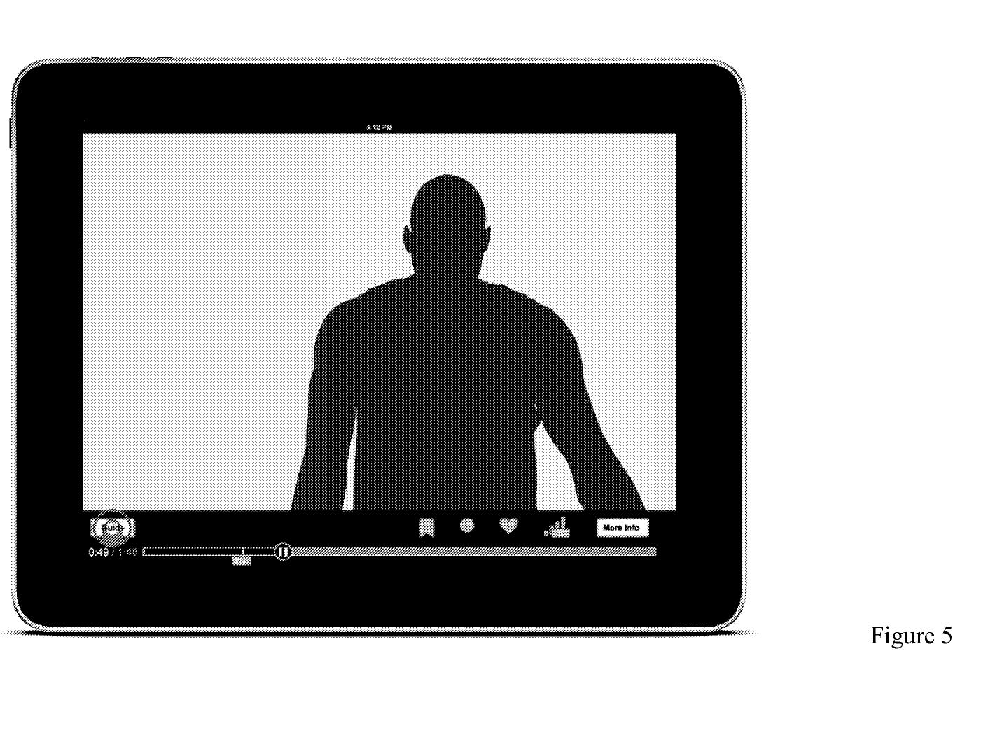

FIG. 5 illustrates an image of an example of a media content playback user interface. According to various embodiments, a media content playback user interface may facilitate the presentation of a media content item. The media content playback user interface may include features such as one or more media content playback controls, media content display areas, and media content playback information portions.

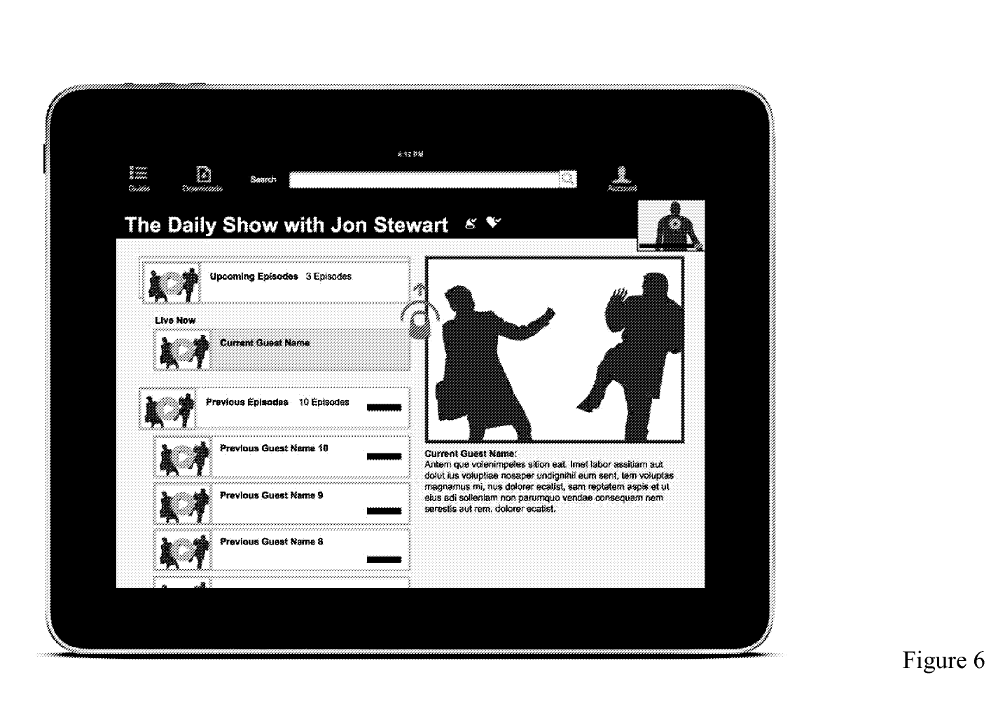

FIG. 6 illustrates an example of a global navigation user interface. According to various embodiments, the global navigation user interface may be used to display information related to a media content item. For instance, the example shown in FIG. 6 includes information related to the media content entity “The Daily Show with Jon Stewart.” In this case, the related information includes links or descriptions of previous and upcoming episodes as well as previous, current, and upcoming guest names. However, a global navigation user guide may display various types of related information, such as cast member biographies, related content, and content ratings. As with many other user interfaces described herein, the global navigation user guide may include an asset overlay for presenting a media clip, which in the example shown in FIG. 6 is displayed in the upper right corner of the display screen. The asset overlay may display content such as a currently playing video feed, which may also be presented on another device such as a television.

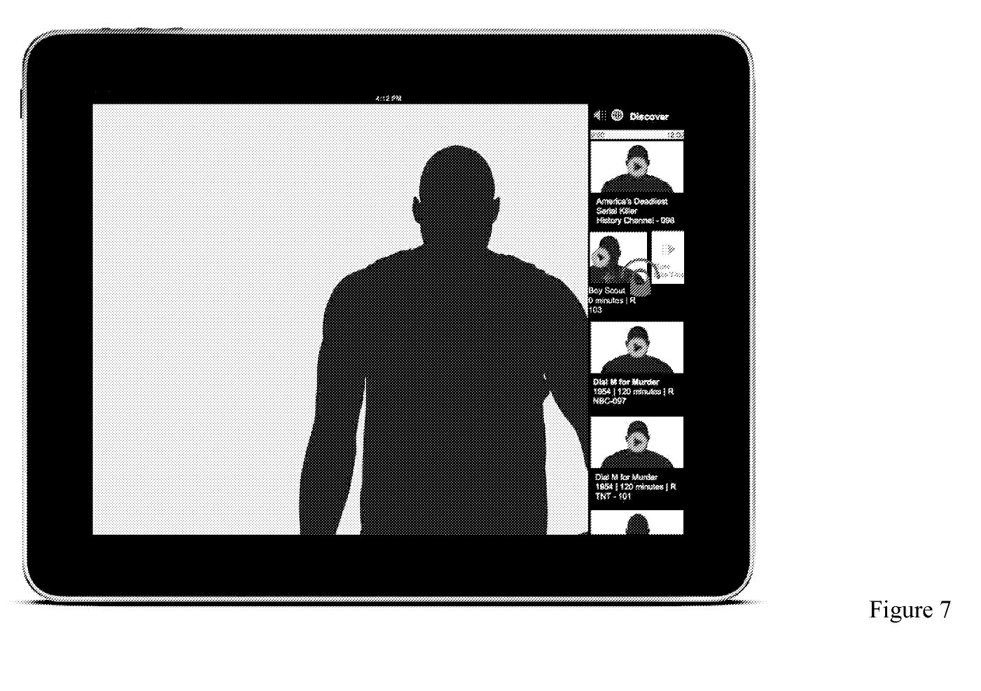

FIG. 7 illustrates an example of a discovery panel user interface within an overlay that appears in front of a currently playing video. According to various embodiments, the discovery panel user interface may include suggestions for other content. For instance, the discovery panel user interface may include information regarding content suggested based on an assumed preference for the content currently being presented. If a television program is being shown, the discovery panel may include information such as movies or other television programs directed to similar topics, movies or television programs that share cast members with the television program being shown, and movies or television programs that often reflect similar preferences to the television program being shown.

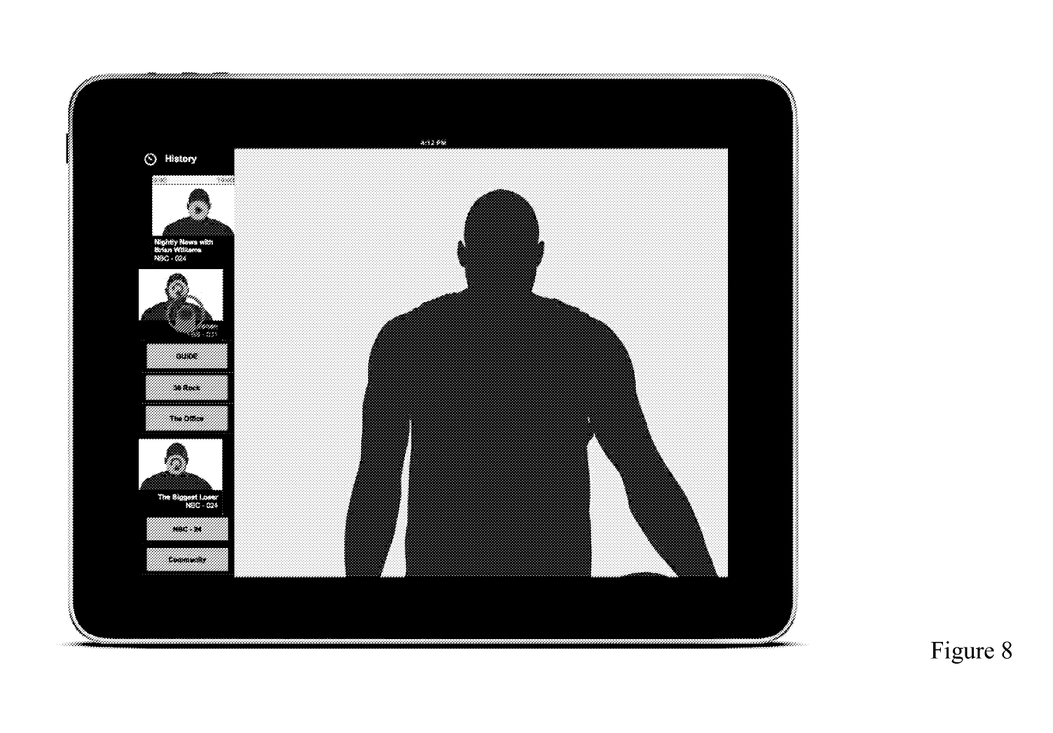

FIG. 8 illustrates an example of a history panel user interface within an overlay that appears in front of a currently playing video. According to various embodiments, the history panel user interface may include information regarding media content items that have been presented in the past. The history panel user interface may display various information regarding such media content items, such as thumbnail images, titles, descriptions, or categories for recently viewed content items.

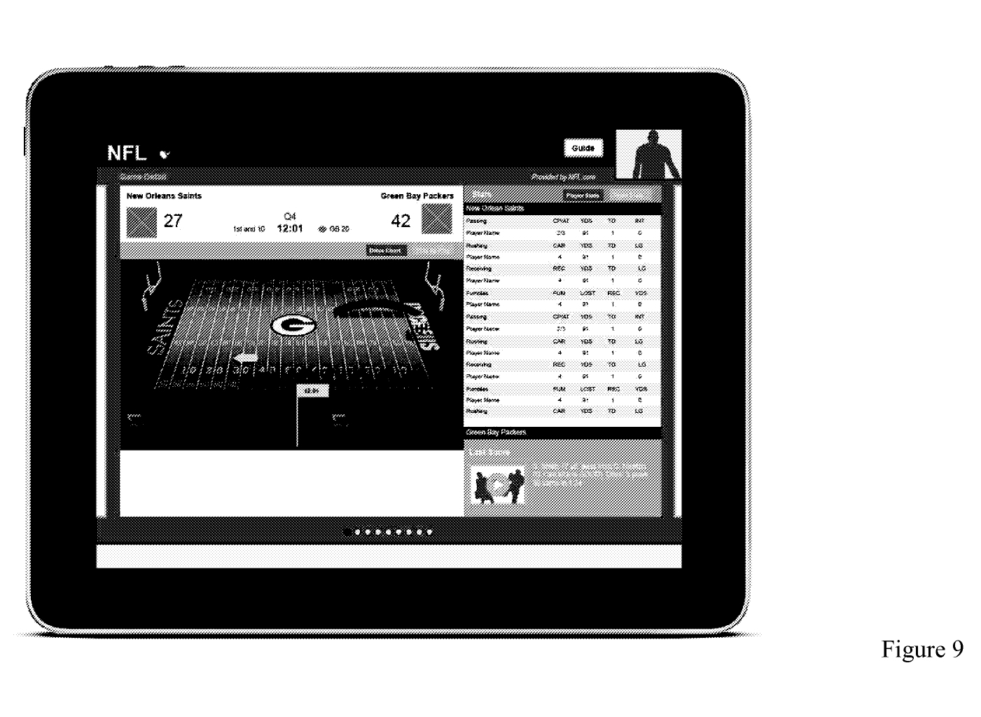

FIG. 9 illustrates an example of an asset overlay user interface configured for companion or co-watching. According to various embodiments, an asset overlay user interface may display information related to content being presented. For example, a user may be watching a football game on a television. At the same time, the user may be viewing related information on a tablet computer such as statistics regarding the players, the score of the game, the time remaining in the game, and the teams' game playing schedules. The asset overlay user interface that presents a smaller scale version of the content being presented on the other device.

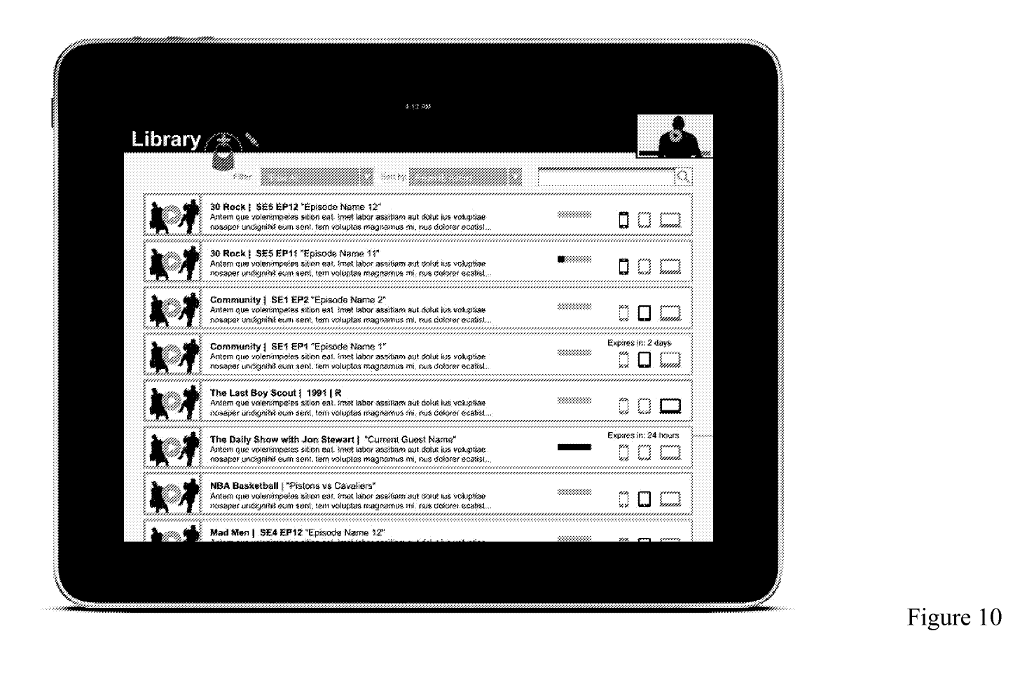

FIG. 10 illustrates an image of an example of a library user interface. According to various embodiments, the library user interface may be used to browse media content items purchased, downloaded, stored, flagged, or otherwise acquired for playback in association with a content management account. The library user interface may include features such as one or more media content item lists, media content item list navigation elements, media content item filtering, sorting, or searching elements. The library user interface may display information such as a description, categorization, or association for each media content item. The library user interface may also indicate a device on which the media content item is stored or may be accessed.

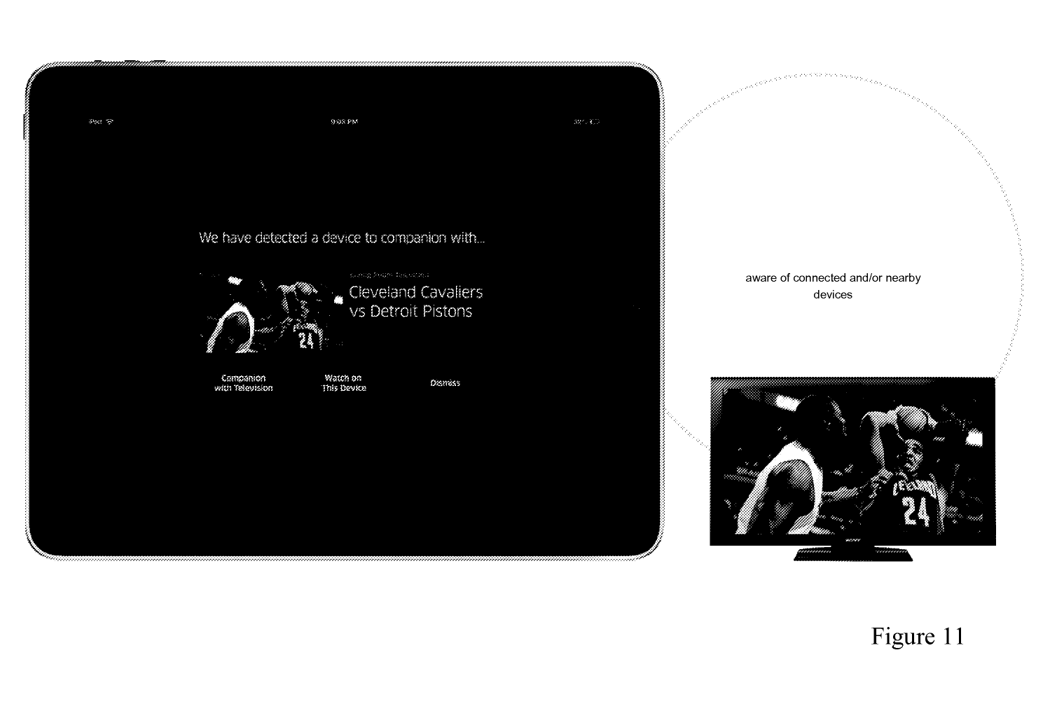

FIGS. 11-15 illustrate images of examples of a connected user interface displayed across two devices. In FIG. 11, a sports program is presented on a television while a content guide is displayed on a tablet computer. Because the television is capable of connecting with the tablet computer, the tablet computer presents an alert message that informs the user of the possibility of connecting. Further, the alert message allows the user to select an option such as watching the television program on the tablet computer, companioning with the television to view related information on the tablet computer, or dismissing the connection.

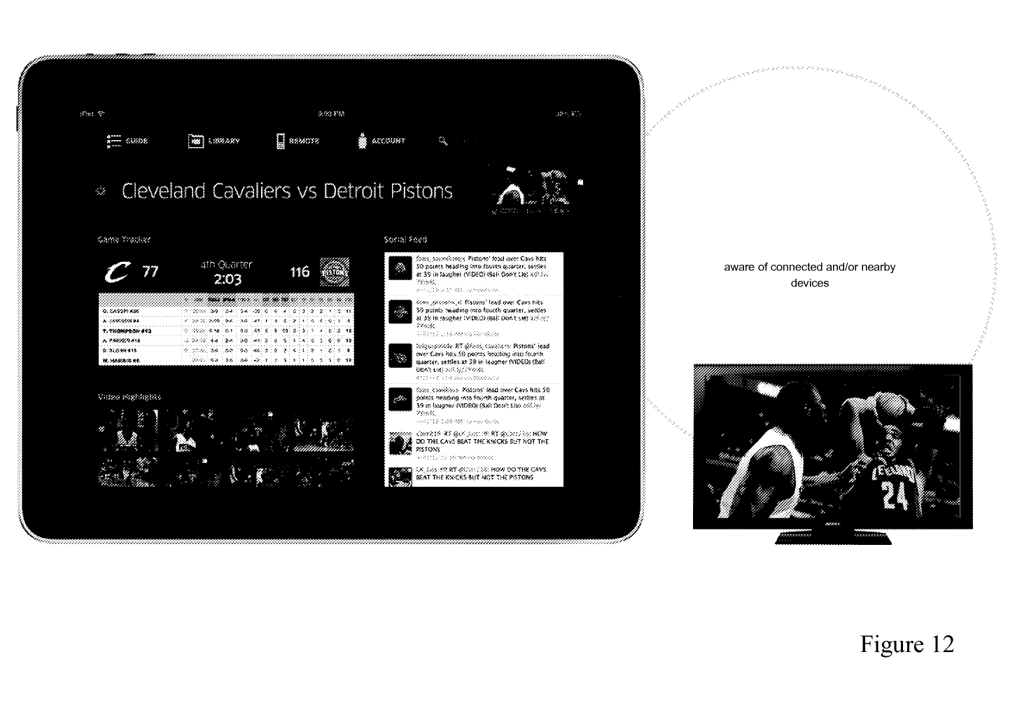

In FIG. 12, the tablet computer is configured for companion viewing. In companion viewing mode, the tablet computer may display information related to the content displayed on the television. For instance, in FIG. 12, the tablet computer is displaying the score of the basketball game, social media commentary related to the basketball game, video highlights from the game, and play statistics. In addition, the tablet computer displays a smaller, thumbnail image sized video of the content displayed on the television.

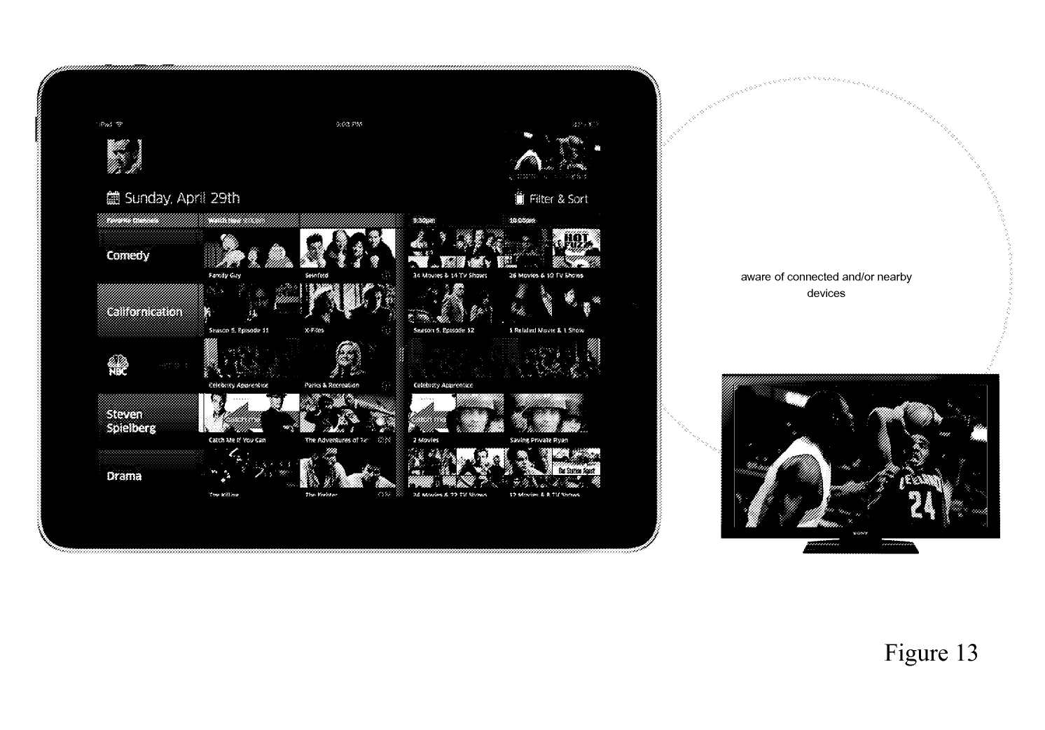

In FIG. 13, the user browses for new content while continuing to view the basketball game in companion mode across the two devices. Accordingly, the tablet computer displays a content guide for selecting other content while continuing to display the smaller, thumbnail image sized video of the basketball game displayed on the television.

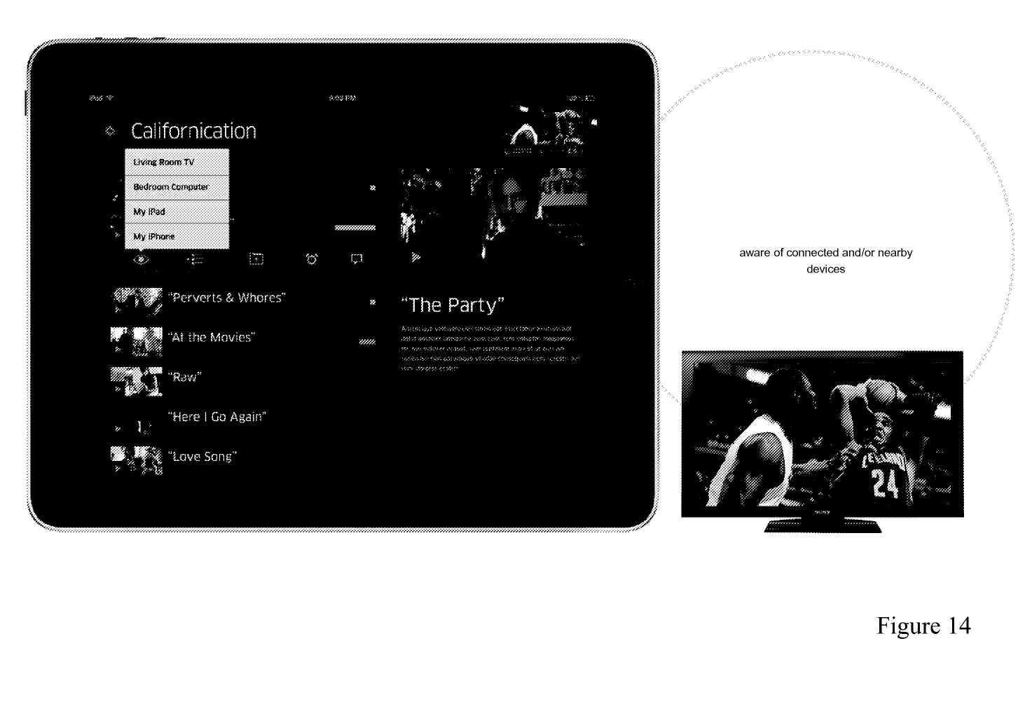

In FIG. 14, the user is in the process of selecting a new media content item for display. Here the new media content item is a television episode called “The Party.” After selecting the media content item, the user may select a device for presenting the content. In FIG. 14, the available devices for selection include the Living Room TV, the Bedroom Computer, My iPad, and My iPhone. By allowing control of content across different devices, the connected user interface can provide a seamless media viewing experience.

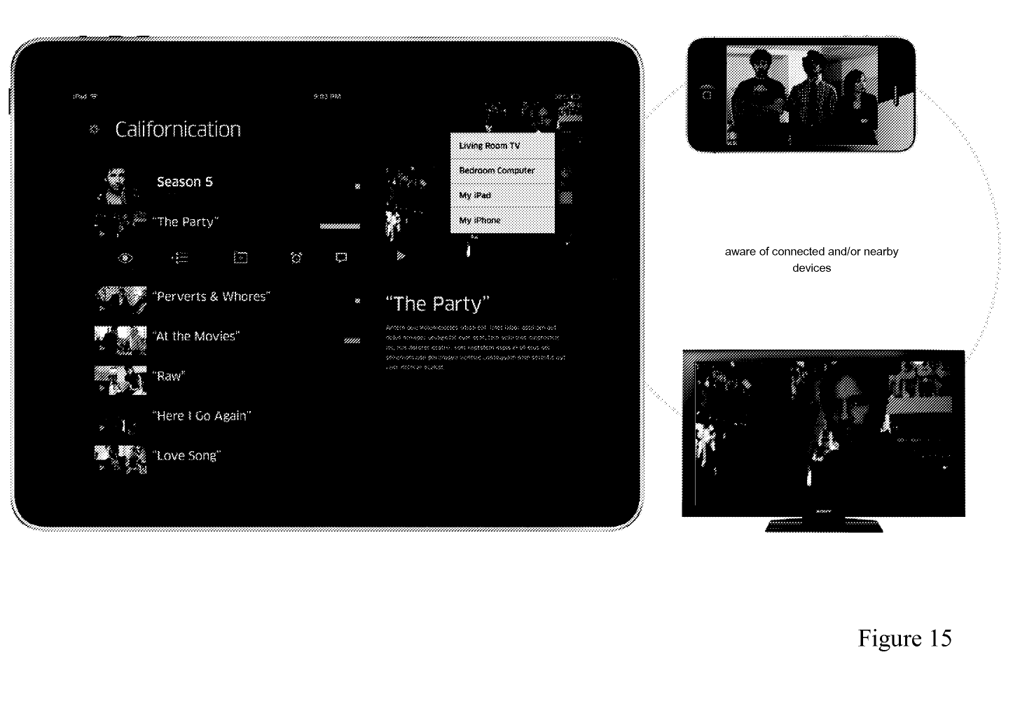

In FIG. 15, the user has selected to view the new television program on the Living Room TV. Additionally, a new device, which is a mobile phone, has entered the set of connected and/or nearby devices. By selecting the device within the user interface, the user can cause the currently playing video to also display on the mobile phone. In this way, the user can continue a video experience without interruption even if the user moves to a different physical location. For example, a user may be watching a television program on a television while viewing related information on a tablet computer. When the user wishes to leave the house, the user may cause the television program to also display on a mobile phone, which allows the user to continue viewing the program.

It should be noted that the user interfaces shown in FIGS. 3-15 are only examples of user interfaces that may be presented in accordance with techniques and mechanisms described herein. According to various embodiments, user interfaces may not include all elements shown in FIGS. 3-15 or may include other elements not shown in FIGS. 3-15. By the same token, the elements of a user interface may be arranged differently than shown in FIGS. 3-15. Additionally, user interfaces may be used to present other types of content, such as music, and may be used in conjunction with other types of devices, such as personal or laptop computers.

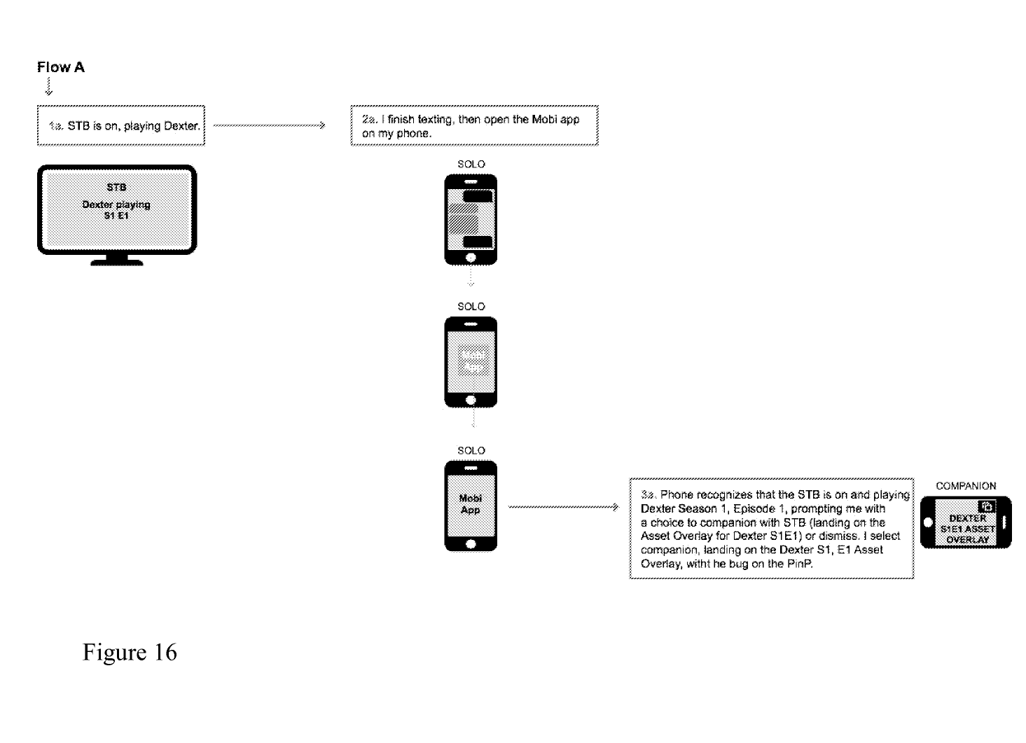

FIGS. 16-18 illustrate examples of techniques for communicating between various devices. In FIG. 16, a mobile device enters companion mode in communication with a television. According to various embodiments, companion mode may be used to establish a connected user interface across different devices. The connected user interface may allow a user to control presentation of media content from different devices, to view content across different devices, to retrieve content from different devices, and to access information or applications related to the presentation of content.

At operation 1a, an episode of the television show “Dexter” is playing on a television, which may also be referred to as a set top box (STB). According to various embodiments, the television show may be presented via any of various techniques. For instance, the television show may be received via a cable television network connection, retrieved from a storage location such as a DVR, or streamed over the Internet from a service provider such as Netflix.

According to various embodiments, the television or an associated device such as a cable box may be capable of communicating information to another device. For example, the television or cable box may be capable of communicating with a server via a network such as the Internet, with a computing device via a local network gateway, or with a computing device directly such as via a wireless network connection. The television or cable box may communicate information such as a current device status, the identity of a media content item being presented on the device, and a content management account associated with the device.

At operation 2a, a communication application is activated on a mobile device that is not already operating in companion mode. The communication application may allow the mobile device to establish a communication session for the purpose of entering into a companion mode with other media devices. When in companion mode, the devices may present a connected user interface for cross-device media display. In the example shown in FIG. 16, the communication application is a mobile phone application provided by MobiTV.

At operation 3a, the mobile phone receives a message indicating that the television is active and is playing the episode of the television show “Dexter.” Then, the mobile phone presents a message that provides a choice as to whether to enter companion mode or to dismiss the connection. When the user selects companion mode, the mobile phone initiates the communications necessary for presenting the connected display. For example, the mobile phone may transmit a request to a server to receive the information to display in the connected display.

In particular embodiments, the connected display may present an asset overlay for the content being viewed. For example, the asset overlay may display information related to the viewed content, such as other episodes of the same television program, biographies of the cast members, and similar movies or television shows. In asset overlay user interface may include a screen portion for displaying a small, thumbnail image sized video of the content being presented on the television. Then, the user can continue to watch the television program even while looking at the mobile phone.

In particular embodiments, a device may transmit identification information such as a content management account identifier. In this way, a server may be able to determine how to pair different devices when more than one connection is possible. When a device is associated with a content management account, the device may display information specific to the content management account such as suggested content determined based on the user's preferences.

In some embodiments, a device may automatically enter companion mode when an available connection is located. For instance, a device may be configured in an “auto-companion” mode. When a first device is in auto-companion mode, opening a second device in proximity to the first device causes the first device to automatically enter companion mode, for instance on the asset overlay page. Dismissing an alert message indicating the possibility of entering companion mode may result in the mobile phone returning to a previous place in the interface or in another location, such as a landing experience for a time-lapsed user. In either case, the television program being viewed on the television may be added to the history panel of the communication application.

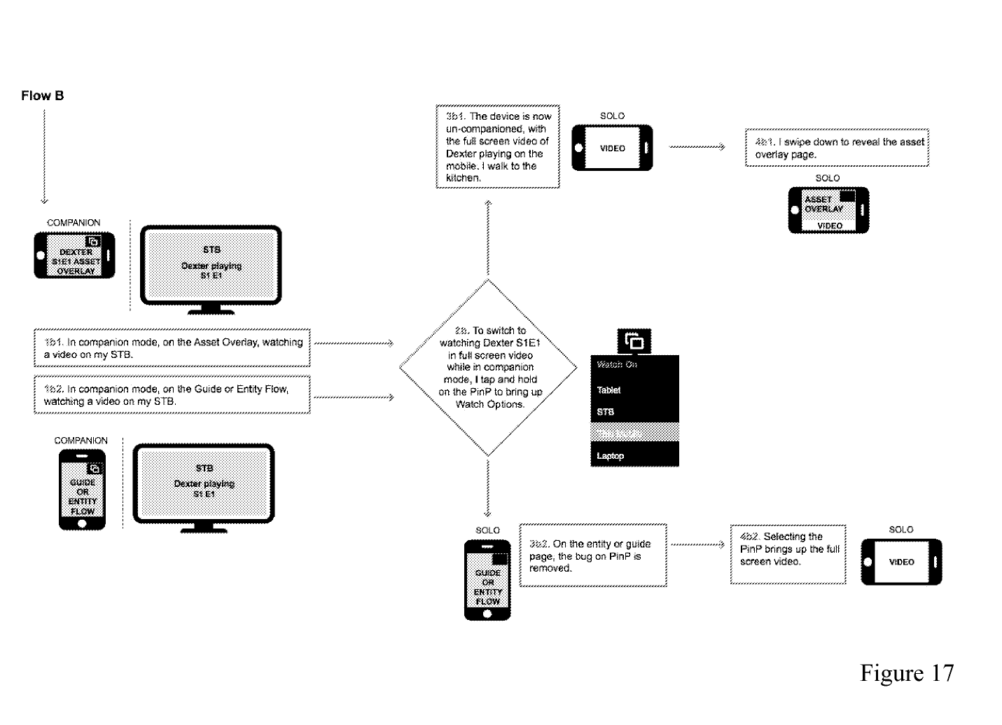

In FIG. 17, techniques are illustrated for displaying a video in full screen mode on a mobile device while the mobile device is in companion mode. Initially, the television is displaying an episode of the “Dexter” television show. At the same time, the mobile device is operating in companion mode. When the video is displayed in full screen mode, the user can, for instance, take the mobile device to a different location while continuing to view the video.

At operation 1b1, the mobile device is displaying an asset overlay associated with the television program as discussed with respect to FIG. 12. At operation 2b1, the mobile device is displaying an electronic program guide or an entity flow as discussed with respect to FIGS. 13-15. In both operations, the mobile device is also displaying a small, picture-in-picture version of the television show displayed on the television screen.

At operation 2b, the user would like to switch to watching the television program in full screen video on the mobile device while remaining in companion mode. In order to accomplish this task, the user activates a user interface element, for instance by tapping and holding on the picture-in-picture portion of the display screen. When the user activates the selection interface, the mobile device displays a list of devices for presenting the content. At this this point, the user selects the mobile device that the user is operating.

At operation 3b1, the device is removed from companion mode. When companion mode is halted, the video playing on the television may now be presented in the mobile device in full screen. According to various embodiments, the device may be removed from proximity of the television while continuing to play the video.

At operation 4b1, the user selects the asset overlay for display on top of, or in addition to, the video. According to various embodiments, various user interface elements may be used to select the asset overlay for display. For example, the user may swipe the touch screen display at the mobile device. As another example, the user may click on a button or press a button on a keyboard.

At operation 3b2, the electronic program guide or entity flow continues to be displayed on the mobile device. At the same time, the “bug” is removed on the picture-in-picture portion of the display screen. As used herein, the term “bug” refers to an icon or other visual depiction. In FIG. 17, the bug indicates that the mobile device is operating in companion mode. Accordingly, the removal of the bug indicates that the device is no longer in companion mode.

At operation 4b2, the video is displayed in full screen mode. According to various embodiments, the video may be displayed in full screen mode by selecting the picture-in-picture interface. Alternately, the video may be automatically displayed in full screen mode when the device is no longer operating in companion mode.

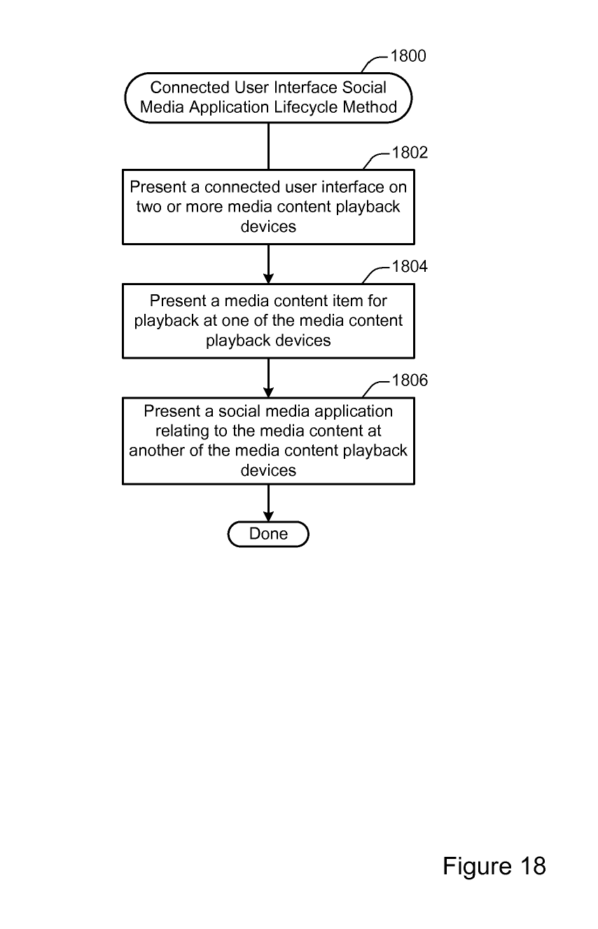

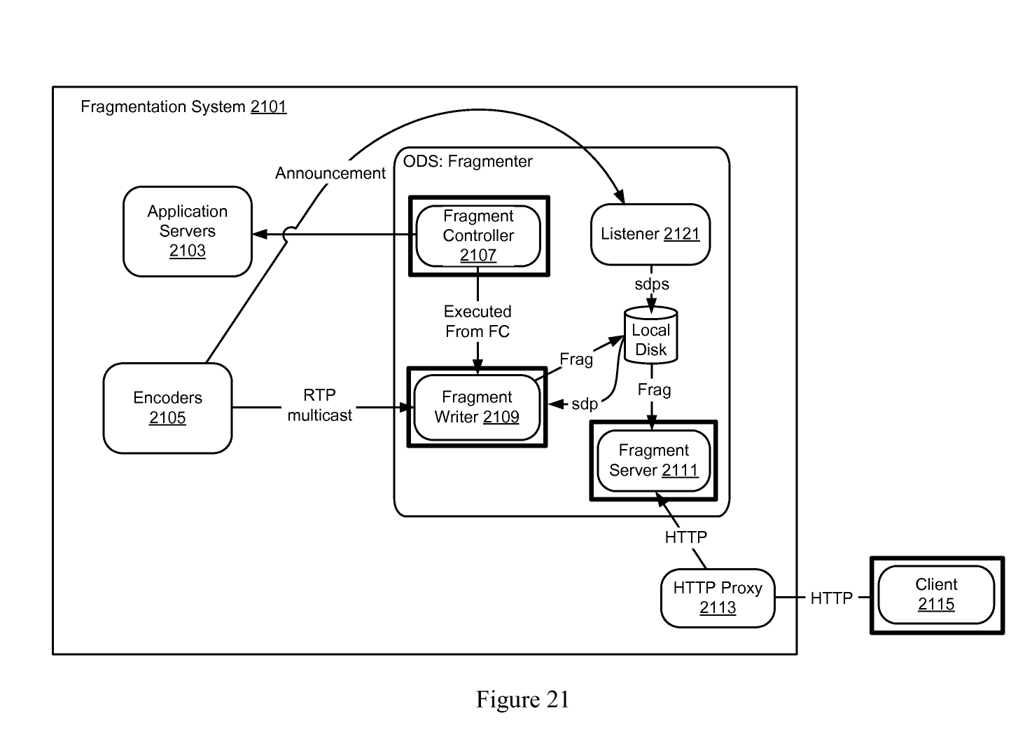

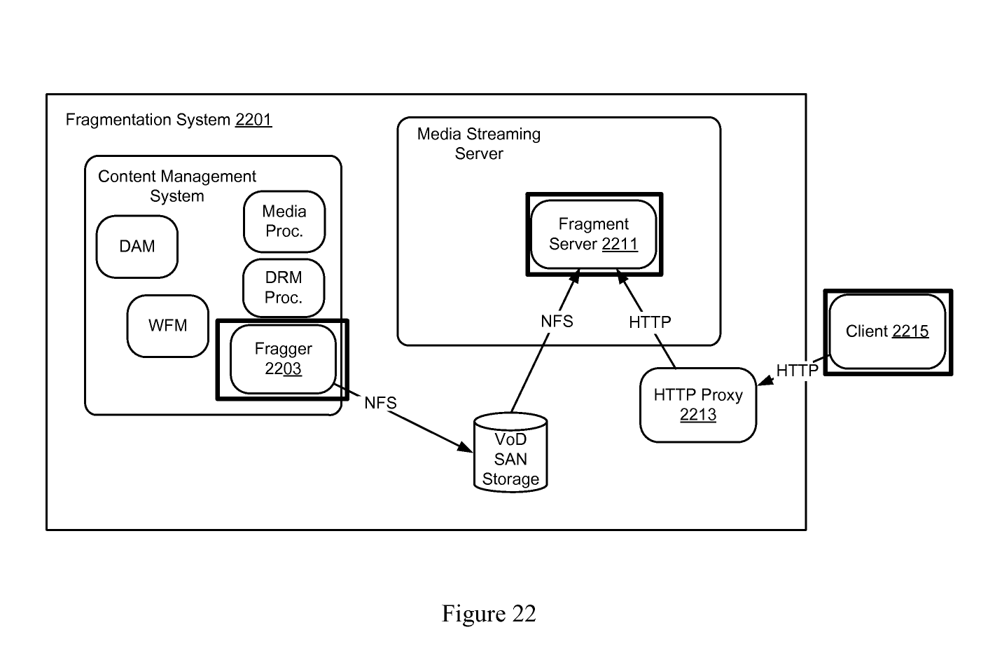

FIG. 18 illustrates a method 1800 for conducting a connected user interface social media application lifecycle. According to various embodiments, the method 1800 may be performed at a media system in communication with a client machine. For instance, the method 1800 may be performed at a media system such as those discussed with respect to FIGS. 21 and 22.

At 1802, a connected user interface is presented on two or more media content playback devices. According to various embodiments, the content playback devices may be any devices capable of presenting media content items for playback. For instance, each content playback device may be a laptop computer, a desktop computer, a tablet computer, a mobile phone, or a television.

According to various embodiments, each of the content playback devices may perform various operations related to content management and/or playback. For example, one content playback device may present media content for playback, while a digital program guide or asset overlay is presented on another content playback device. As another example, one content playback device may present media content for playback in a full screen mode while another content playback device presents content in a windowed, picture-in-picture playback mode to allow other ports of a display screen to be used for other purposes.

At 1804, a media content item is presented for playback at one of the media content playback devices. According to various embodiments, the media content item may be retrieved from any of a variety of media content sources. For example, the media content item may be streamed or downloaded from an internet content service provider such as iTunes or Netflix. As another example, the media content item may be transmitted from the media system. As yet another example, the media content item may be retrieved from a local or network storage location.

According to various embodiments, the media content item may be presented when it selected by a user. For instance, a user may select the media content item for playback from a digital content guide or from an asset overlay. In particular embodiments, the user may also select a media content device for presenting the media content item. For instance, the user may select any active media playback device associated with the content management account.

At 1806, a social media application relating to the media content is presented at another of the media content playback devices. According to various embodiments, the social media application may be any application capable of facilitating the exchange of user-generated content. For instance, the social media application may facilitate interaction via Facebook, Twitter, YouTube, or any other social media service.

According to various embodiments, the social media application may be provided from any of a variety of sources. For example, the social media application may be provided by the media system. As another example, the social media application may be provided by a social networking system such as Facebook, Twitter, or YouTube.

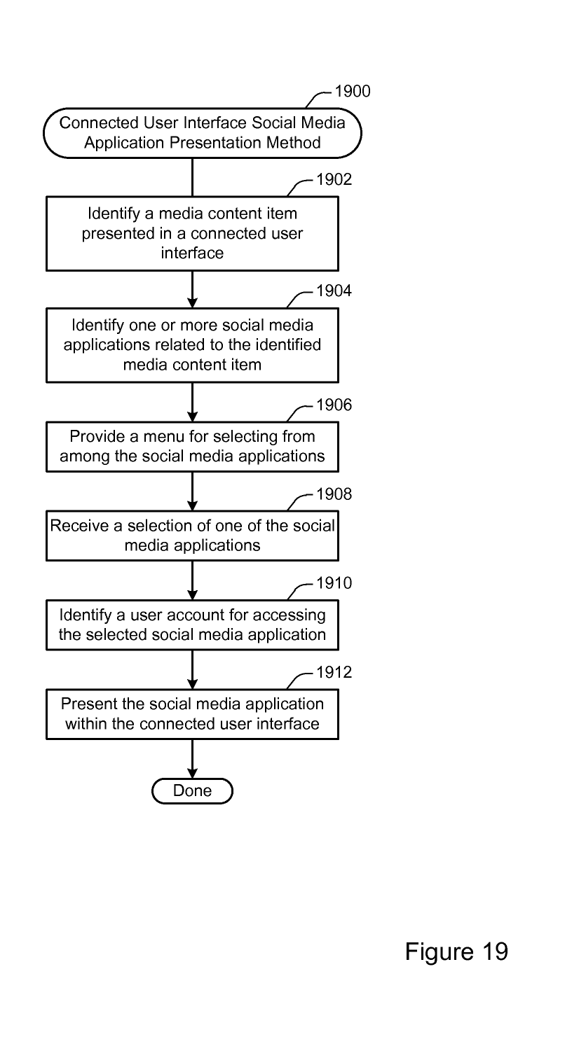

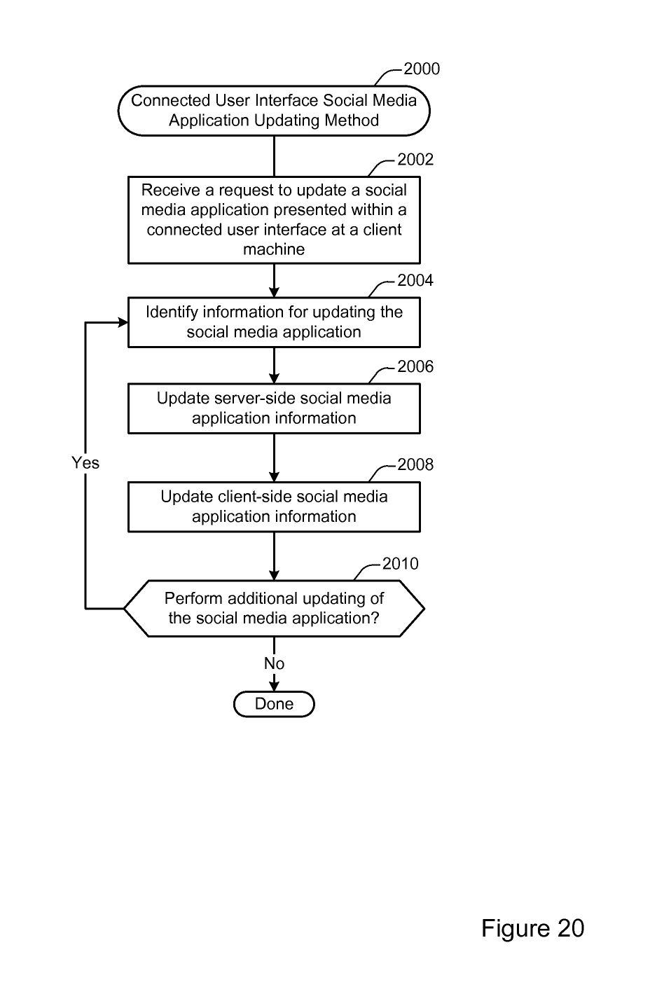

According to various embodiments, the social media application may facilitate interaction regarding the specific media content item presented for playback as discussed in operation 1804. For instance, the social media application may facilitate the exchange of content ratings or comments regarding the media content item. The presentation and updating of a social media application in a connected user interface are described in further detail with respect to FIGS. 19 and 20.

FIG. 19 illustrates a method 1900 for presenting a connected user interface social media application. According to various embodiments, the method 1900 may be performed at a media system in communication with potentially many client machines. The method 1900 may be used to provide a menu for selecting from among a variety of social media applications. Then, when one of the social media applications is selected, it is provided at a client machine within a connected user interface.

At 1902, a media content item presented in a connected user interface is identified. According to various embodiments, the media content item may be any media content item accessible via the media system. For instance, the media content item may be a television program, a movie, or any digital video or audio content. The media content item may be received from any of a variety of content sources, which may include, but are not limited to: a broadcast network such as cable or satellite television, an online digital content service such as Netflix or iTunes, or a local or network storage location.

At 1904, one or more social media applications related to the media content item are identified. According to various embodiments, the social media applications may include any applications for exchanging user-generated content related to the identified media content item. The identified social media applications may include general applications, such as a Facebook or Twitter application, or specific applications, such as a “Mad Men” community application. The identified social media applications may include applications that are focused on general content such as a television show or specific content such as a particular television show episode.

According to various embodiments, one or more social media applications may be associated with a content management account. For instance, a user may indicate that he or she has accounts associated with a designated list of social media services. Alternately, or additionally, a social media application may be associated with a media content item regardless of whether a particular content management account is associated with a user account for the social media application. For instance, a social media application may provide access to blogs and mainstream media sources related to a media content item. These media sources may not require a user account but may still facilitate the exchange of user-generated content such as comments.

According to various embodiments, the social media application may aggregate secondary media content concerning the specific media content item presented for playback. For example, for the television show “Mad Men”, the social media application may present the user with relevant articles from mainstream media and web logs (blogs) concerning the show in general or a particular episode. For instance, the social media application may present the user with links to or content from The New York Times' “Arts Beat” blog, providing a summary of the most recent episode, and Slate.com's “TV Club”, an online discussion of the show by staff journalists with comments by other readers. The social media application may also present links to non-mainstream media content, such as blog posts, that relate to the show in general or to a particular episode of the show. For example, the social media application may present links to discussions and articles from professional blogs such as “The A.V. Club” or “The Hitfix” blogs and/or fan-based blogs such as “Basket of Kisses.”

According to various embodiments, the social media application may facilitate the exchange of user-generated content. For instance, the social media application may highlight in particular mainstream news articles or blogs that are read by, shared, or “liked” by peers in the user's social network in order to make social recommendations of such content. For example, if a user's Facebook friend or Google Circle member expresses a preference for Slate.com's “TV Club” online discussion, then that secondary media source can be highlighted and/or positioned at the top of a list of recommended social media content presented in the social media application. As another example, the social media application may also allow the user to selectively subscribe to certain comment feeds and discussions and be alerted when new comments are made to a particular article, blog post, or Facebook comment thread.

According to various embodiments, the social media application may allow a user to join a discussion via a commenting mechanism, indicate a “like” of the discussion on Facebook, or share the discussion with the user's social network via a social media service such as Facebook or Twitter. For instance, the user may subscribe to a particular comment thread of a discussion on Slate.com of the most recent episode of Mad Men. Then, through the social media application, the user may post his or her own comment to the discussion and share the comment with his or her social network. This sharing may then generate additional discussion or feedback by the user's friends and other social connections.

According to various embodiments, the social media application may aggregate secondary social media content concerning the specific media content item presented for playback. In some cases, this aggregation may be based on information available from social media services in which the user participates. For example, the social media application can generate content suggestions based on the user's friends, self-description, interests, and other information expressed or available on a social network such as Facebook, Twitter, or LinkedIn. For instance, if the user's occupation is in graphic design and the user lists “design” or “history” as a personal interest, the social media application may present the user with media content recommendations related to interior design, typography, or American mid-century history.

According to various embodiments, the social media application can aggregate social media content based on the user's viewing history and search history. For example, the user may have searched for media content featuring Jon Hamm, the lead actor in “Mad Men,” or may have a history of viewing movies and shows in which he stars. In this case, the social media application can suggest that the user “subscribe” to Jon Hamm's Facebook page or “follow” Jon Hamm's Twitter account.

According to various embodiments, the social media application may analyze aggregated social media and e-commerce information based on the user's social media activities. For example, a user may “pin” pictures from Mad Men onto their “My Style” board on the image sharing site Pinterest or post a collage of clothing inspired by the fashions of Mad Men to the collage sharing site Polyvore. Then, the social media application may recommend other Pinterest or Polyvore boards to follow that are similar in content or style. Also, the social media application may recommend other media content items that elicited similar social media reactions from other users. For example, the social media application can suggest that the user view social media content or media content items boards that are categorized as “vintage” or “retro.”

At 1906, a menu for selecting from among the social media applications is provided. According to various embodiments, an instruction for providing the menu may be transmitted from the media system to a client machine. In some instances, the client machine may be the machine at which the content item is presented. In other instances, the client machine may be another machine, such as a client machine displaying a content guide or other user interface portions.

At 1908, a selection of one or more of the social media applications is received. The selection of one or more of the social media applications may be received at the client machine and transmitted to the media system. In particular embodiments, the selection may be processed by the media system. Alternately, the selection may be transmitted to a third party social media service.

At 1910, a user account for accessing the selected social media application is identified. According to various embodiments, the user account may be identified by login information such as a username and password. This information may be provided by a user at the client machine. Alternately, or additionally, the information may be stored in association with the content management account and retrieved when the social media application is selected or access. In some cases, the identifying information may be associated with a third party account such as Facebook or Twitter. In other cases, the identifying information may identify the content management account associated with content presentation, for instance when the social media application is provided by the media system.

At 1912, the social media application is presented within the connected user interface. According to various embodiments, the social media application may be presented within the connected user interface. For instance, the social media application may be presented at one content playback device, while another content playback device presents the media content item. When the social media application is displayed, it may be displayed on the entire area of the display screen or within a portion of the display screen. For instance, a portion of the display screen may display a smaller scale, picture-in-picture version of a media content item, while another portion of the display screen is used to display the social media application.

According to various embodiments, one or more of the operations shown in FIG. 19 may be omitted. For instance, some social media applications may not require a user account for access. In such instances, the operation 1910 may be omitted. Alternately, or additionally, the method 1900 may include one or more operations not shown in FIG. 19. For instance, a user may provide an indication of which social media applications to present in association with the content management account.

FIG. 20 illustrates a method 2000 for updating a connected user interface social media application. According to various embodiments, the method 2000 may be performed at a media system, such as the media systems discussed with respect to FIGS. 21 and 22. The method 2000 may be used to monitor, analyze, and update a social media application presented as discussed with respect to FIG. 19.

At 2002, a request to update a social media application is received. According to various embodiments, the request may be received at the media system providing the connected user interface. Alternately, the request may be received at a third party social media service. In some cases, the request may be received from the client machine. For instance, the client machine may transmit a request for new information to display within the social media application. In other cases, the request may be received from the social media service. For example, the social media service may transmit a request to push information out to the social media application presented at the client machine.

At 2004, information for updating the social media application is identified. According to various embodiments, the information may be received from any of various sources. For instance, the information may be received from the media system, from a social media service, or from the client machine. The information may include any data capable of being used for client-side and/or server-side social media application updating.

At 2006, server-side social media application information is updated. According to various embodiments, updating the server-side social media application information may involve storing any new information at the media system and/or the social media service. The updated information may include, but is not limited to: new media content recommendations, the user's social media service contacts, information regarding other aspects of the social media service, inferences regarding the user's content viewing preferences, information related to the content management account, and any information discussed with respect to the presentation of the social media application in FIG. 19.

At 2008, client-side social media application information is updated. According to various embodiments, updating the client-side social media application information may involve transmitting a message to the client machine instructing the client machine to display new information. The new information may include any information capable of being presented in conjunction with the client-side social media application. For instance, the information may include, but is not limited to: new comments or content recommendations, new information regarding members of a user's social network, new articles or news regarding a media content item or media content category, new social media service status information, and any information discussed with respect to the presentation of the social media application in FIG. 19.

At 2010, a determination is made as to whether to perform additional updating of the social media application. According to various embodiments, the determination may be made at least in part based on whether the social media application continues to be presented at the client machine. If the social media application continues to be presented and if additional information for updating the social media application is received, then additional updating may be performed.

FIG. 21 is a diagrammatic representation illustrating one example of a fragment or segment system 2101 associated with a content server that may be used in a broadcast and unicast distribution network. Encoders 2105 receive media data from satellite, content libraries, and other content sources and sends RTP multicast data to fragment writer 2109. The encoders 2105 also send session announcement protocol (SAP) announcements to SAP listener 2121. According to various embodiments, the fragment writer 2109 creates fragments for live streaming, and writes files to disk for recording. The fragment writer 2109 receives RTP multicast streams from the encoders 2105 and parses the streams to repackage the audio/video data as part of fragmented MPEG-4 files. When a new program starts, the fragment writer 2109 creates a new MPEG-4 file on fragment storage and appends fragments. In particular embodiments, the fragment writer 2109 supports live and/or DVR configurations.

The fragment server 2111 provides the caching layer with fragments for clients. The design philosophy behind the client/server application programming interface (API) minimizes round trips and reduces complexity as much as possible when it comes to delivery of the media data to the client 2115. The fragment server 2111 provides live streams and/or DVR configurations.

The fragment controller 2107 is connected to application servers 2103 and controls the fragmentation of live channel streams. The fragmentation controller 2107 optionally integrates guide data to drive the recordings for a global/network DVR. In particular embodiments, the fragment controller 2107 embeds logic around the recording to simplify the fragment writer 2109 component. According to various embodiments, the fragment controller 2107 will run on the same host as the fragment writer 2109. In particular embodiments, the fragment controller 2107 instantiates instances of the fragment writer 2109 and manages high availability.

According to various embodiments, the client 2115 uses a media component that requests fragmented MPEG-4 files, allows trick-play, and manages bandwidth adaptation. The client communicates with the application services associated with HTTP proxy 2113 to get guides and present the user with the recorded content available.

FIG. 22 illustrates one example of a fragmentation system 2201 that can be used for video-on-demand (VoD) content. Fragger 2203 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 2211 provides the caching layer with fragments for clients. The design philosophy behind the client/server API minimizes round trips and reduces complexity as much as possible when it comes to delivery of the media data to the client 2215. The fragment server 2211 provides VoD content.

According to various embodiments, the client 2215 uses a media component that requests fragmented MPEG-4 files, allows trick-play, and manages bandwidth adaptation. The client communicates with the application services associated with HTTP proxy 2213 to get guides and present the user with the recorded content available.

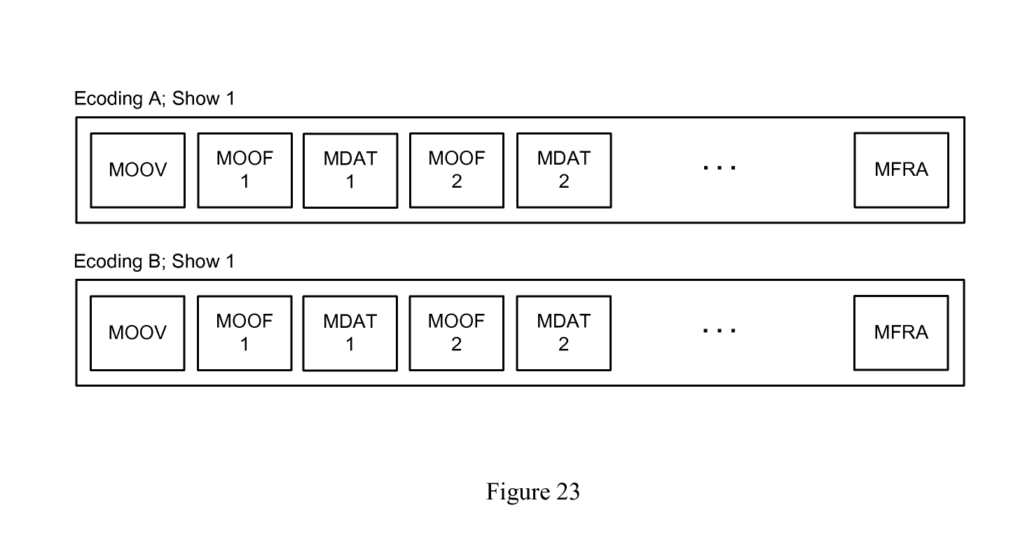

FIG. 23 illustrates examples of files stored by the fragment writer. According to various embodiments, the fragment writer is a component in the overall fragmenter. It is a binary that uses command line arguments to record a particular program based on either NTP time from the encoded stream or wallclock time. In particular embodiments, this is configurable as part of the arguments and depends on the input stream. When the fragment writer completes recording a program, it exits. For live streams, programs are artificially created to be short time intervals e.g. 5-15 minutes in length.

According to various embodiments, the fragment writer command line arguments are the SDP file of the channel to record, the start time, end time, name of the current and next output files. The fragment writer listens to RTP traffic from the live video encoders and rewrites the media data to disk as fragmented MPEG-4. According to various embodiments, media data is written as fragmented MPEG-4 as defined in MPEG-4 part 12 (ISO/IEC 14496-12). Each broadcast show is written to disk as a separate file indicated by the show ID (derived from EPG). Clients include the show ID as part of the channel name when requesting to view a prerecorded show. The fragment writer consumes each of the different encodings and stores them as a different MPEG-4 fragment.

In particular embodiments, the fragment writer writes the RTP data for a particular encoding and the show ID field to a single file. Inside that file, there is metadata information that describes the entire file (MOOV blocks). Atoms are stored as groups of MOOF/MDAT pairs to allow a show to be saved as a single file. At the end of the file there is random access information that can be used to enable a client to perform bandwidth adaptation and trick play functionality.

According to various embodiments, the fragment writer includes an option which encrypts fragments to ensure stream security during the recording process. The fragment writer will request an encoding key from the license manager. The keys used are similar to that done for DRM. The encoding format is slightly different where MOOF is encoded. The encryption occurs once so that it does not create prohibitive costs during delivery to clients.

The fragment server responds to HTTP requests for content. According to various embodiments, it provides APIs that can be used by clients to get necessary headers required to decode the video and seek any desired time frame within the fragment and APIs to watch channels live. Effectively, live channels are served from the most recently written fragments for the show on that channel. The fragment server returns the media header (necessary for initializing decoders), particular fragments, and the random access block to clients. According to various embodiments, the APIs supported allow for optimization where the metadata header information is returned to the client along with the first fragment. The fragment writer creates a series of fragments within the file. When a client requests a stream, it makes requests for each of these fragments and the fragment server reads the portion of the file pertaining to that fragment and returns it to the client.

According to various embodiments, the fragment server uses a REST API that is cache-friendly so that most requests made to the fragment server can be cached. The fragment server uses cache control headers and ETag headers to provide the proper hints to caches. This API also provides the ability to understand where a particular user stopped playing and to start play from that point (providing the capability for pause on one device and resume on another).

In particular embodiments, client requests for fragments follow the following format: http://{HOSTNAME}/frag/{CHANNEL}/{BITRATE}/[{ID}/]{COMMAND}[/{ARG}] e.g. http://frag.hostty.com/frag/1/H8QVGAH264/1270059632.mp4/fragment/42. According to various embodiments, the channel name will be the same as the backend-channel name that is used as the channel portion of the SDP file. VoD uses a channel name of “vod”. The BITRATE should follow the BITRATE/RESOLUTION identifier scheme used for RTP streams. The ID is dynamically assigned. For live streams, this may be the UNIX timestamp; for DVR this will be a unique ID for the show; for VoD this will be the asset ID. The ID is optional and not included in LIVE command requests. The command and argument are used to indicate the exact command desired and any arguments. For example, to request chunk 42, this portion would be “fragment/42”.

The URL format makes the requests content delivery network (CDN) friendly because the fragments will never change after this point so two separate clients watching the same stream can be serviced using a cache. In particular, the head end architecture leverages this to avoid too many dynamic requests arriving at the Fragment Server by using an HTTP proxy at the head end to cache requests.

According to various embodiments, the fragment controller is a daemon that runs on the fragmenter and manages the fragment writer processes. A configured filter that is executed by the fragment controller can be used to generate the list of broadcasts to be recorded. This filter integrates with external components such as a guide server to determine which shows to record and which broadcast ID to use.

According to various embodiments, the client includes an application logic component and a media rendering component. The application logic component presents the user interface (UI) for the user, communicates to the front-end server to get shows that are available for the user, and authenticates the content. As part of this process, the server returns URLs to media assets that are passed to the media rendering component.

In particular embodiments, the client relies on the fact that each fragment in a fragmented MP4 file has a sequence number. Using this knowledge and a well-defined URL structure for communicating with the server, the client requests fragments individually as if it was reading separate files from the server simply by requesting URLs for files associated with increasing sequence numbers. In some embodiments, the client can request files corresponding to higher or lower bit rate streams depending on device and network resources.

Since each file contains the information needed to create the URL for the next file, no special playlist files are needed, and all actions (startup, channel change, seeking) can be performed with a single HTTP request. After each fragment is downloaded, the client assesses, among other things, the size of the fragment and the time needed to download it in order to determine if downshifting is needed or if there is enough bandwidth available to request a higher bit rate.

Because each request to the server looks like a request to a separate file, the response to requests can be cached in any HTTP Proxy, or be distributed over any HTTP based content delivery network CDN.

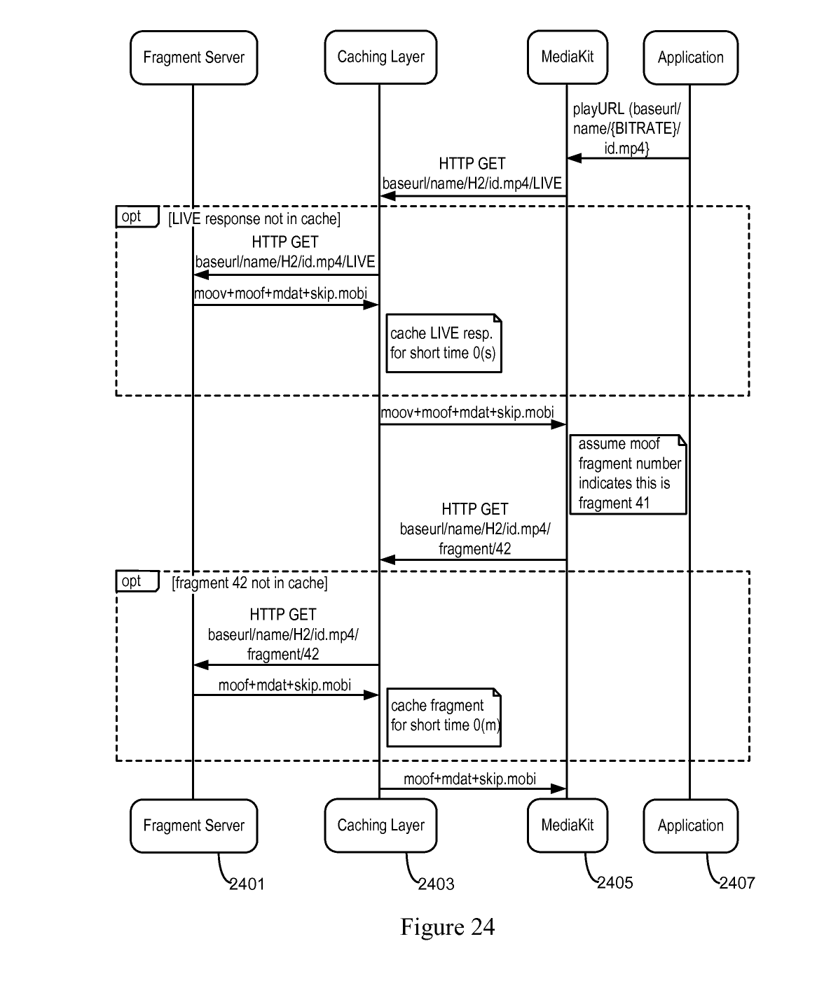

FIG. 24 illustrates an interaction for a client receiving a media stream such as a live stream. The client starts playback when fragment 41 plays out from the server. The client uses the fragment number so that it can request the appropriate subsequent file fragment. An application such as a player application 2407 sends a request to mediakit 2405. The request may include a base address and bit rate. The mediakit 2405 sends an HTTP get request to caching layer 2403. According to various embodiments, the live response is not in cache, and the caching layer 2403 forwards the HTTP get request to a fragment server 2401. The fragment server 2401 performs processing and sends the appropriate fragment to the caching layer 2403 which forwards to the data to mediakit 2405.

The fragment may be cached for a short period of time at caching layer 2403. The mediakit 2405 identifies the fragment number and determines whether resources are sufficient to play the fragment. In some examples, resources such as processing or bandwidth resources are insufficient. The fragment may not have been received quickly enough, or the device may be having trouble decoding the fragment with sufficient speed. Consequently, the mediakit 2405 may request a next fragment having a different data rate. In some instances, the mediakit 2405 may request a next fragment having a higher data rate. According to various embodiments, the fragment server 2401 maintains fragments for different quality of service streams with timing synchronization information to allow for timing accurate playback.

The mediakit 2405 requests a next fragment using information from the received fragment. According to various embodiments, the next fragment for the media stream may be maintained on a different server, may have a different bit rate, or may require different authorization. Caching layer 2403 determines that the next fragment is not in cache and forwards the request to fragment server 2401. The fragment server 2401 sends the fragment to caching layer 2403 and the fragment is cached for a short period of time. The fragment is then sent to mediakit 2405.

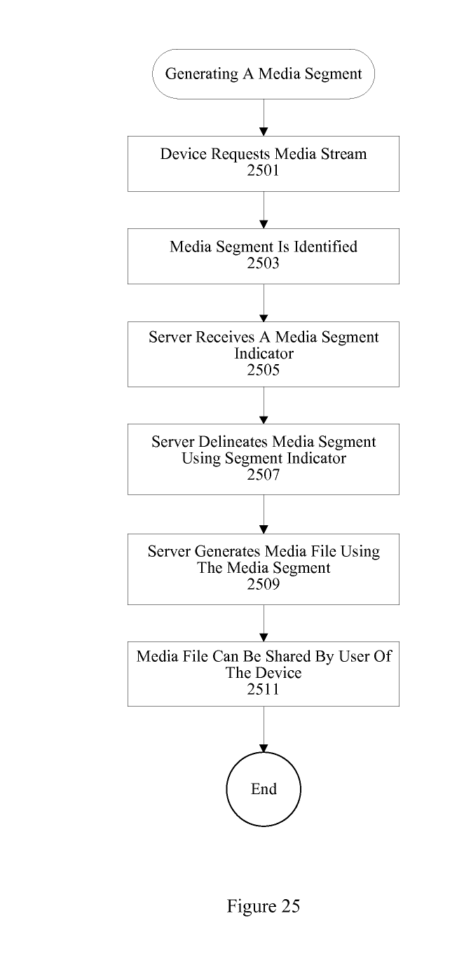

FIG. 25 illustrates a particular example of a technique for generating a media segment. According to various embodiments, a media stream is requested by a device at 2501. The media stream may be a live stream, media clip, media file, etc. The request for the media stream may be an HTTP GET request with a baseurl, bit rate, and file name. At 2503, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 2505, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 2507. The media stream may only be available in a channel buffer. At 2509, the server generates a media file using the media segment maintained in cache. The media file can then be shared by a user of the device at 2511. In some examples, the media file itself is shared while in other examples, a link to the media file is shared.

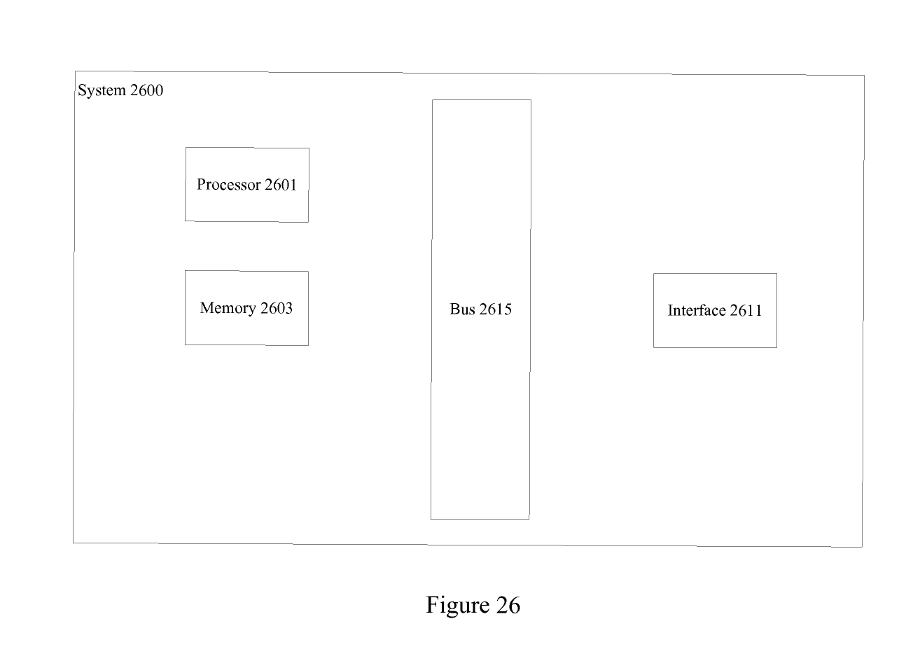

FIG. 26 illustrates one example of a server. According to particular embodiments, a system 2600 suitable for implementing particular embodiments of the present invention includes a processor 2601, a memory 2603, an interface 2611, and a bus 2615 (e.g., a PCI bus or other interconnection fabric) and operates as a streaming server. When acting under the control of appropriate software or firmware, the processor 2601 is responsible for modifying and transmitting live media data to a client. Various specially configured devices can also be used in place of a processor 2601 or in addition to processor 2601. The interface 2611 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 2600 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
receiving a selection of one of a plurality of media content items available for presentation in association with a content management account;
presenting the selected media content item at a first client machine associated with the content management account; and
transmitting a message to a second client machine associated with the content management account, the message including an instruction for displaying a social media application at the second client machine, the social media application facilitating the exchange of user-generated content related to the selected media content item.

2. The method recited in claim 1, wherein the social media application facilitates interaction with a social media service, and wherein the second client machine is associated with a social media service user account for interacting with the social media service.

3. The method recited in claim 1, wherein the social media application is operable to present, at the second client machine, an indication of one or more web pages related to the selected media content item.

4. The method recited in claim 1, wherein facilitating the exchange of user-generated content comprises facilitating the exchange of comments relating to the selected media content item, the comments being exchanged via a social media service associated with the social media application.

5. The method recited in claim 1, wherein the social media application facilitates the exchange of user-generated content via a social network selected from the group consisting of: Google Plus, Facebook, and Twitter.

6. The method recited in claim 1, wherein one or more of the media content items are capable of being viewed on a plurality of computing devices associated with the content management account, and wherein the plurality of computing devices includes the first and second client machines.

7. The method recited in claim 6, wherein receiving the selection of one of the plurality of media content items comprises receiving information designating the first client machine for presenting the selected media content item.

8. The method recited in claim 1, wherein presenting the selected media content item at the first client machine comprises transmitting a video stream to the first client machine via a network.

9. The method recited in claim 1, wherein each of the plurality of the media content items is available from a respective media content source, wherein the media content sources include at least two different media content sources, and wherein at least one of the media content sources is a media content service provider in communication with the client machine via a network.

10. A system comprising:
a memory module operable to store a received selection of one of a plurality of media content items available for presentation in association with a content management account;
one or more processors operable to provide a first instruction for presenting the selected media content item at a first client machine associated with the content management account; and
a communications interface operable to transmit a message to a second client machine associated with the content management account, the message including a second instruction for displaying a social media application at the second client machine, the social media application facilitating the exchange of user-generated content related to the selected media content item.

11. The system recited in claim 10, wherein the social media application facilitates interaction with a social media service, and wherein the second client machine is associated with a social media service user account for interacting with the social media service.

12. The system recited in claim 10, wherein the social media application is operable to present, at the second client machine, an indication of one or more web pages related to the selected media content item.

13. The system recited in claim 10, wherein facilitating the exchange of user-generated content comprises facilitating the exchange of comments relating to the selected media content item, the comments being exchanged via a social media service associated with the social media application.

14. The system recited in claim 10, wherein the social media application facilitates the exchange of user-generated content via a social network selected from the group consisting of: Google Plus, Facebook, and Twitter.

15. The system recited in claim 10, wherein one or more of the media content items are capable of being viewed on a plurality of computing devices associated with the content management account, the plurality of computing devices including the first and second client machines.

16. The system recited in claim 10, wherein receiving the selection of one of the plurality of media content items comprises receiving information designating the first client machine for presenting the selected media content item.

17. One or more computer readable media having instructions stored thereon for performing a method, the method comprising:
receiving a selection of one of a plurality of media content items available for presentation in association with a content management account;
presenting the selected media content item at a first client machine associated with the content management account; and
transmitting a message to a second client machine associated with the content management account, the message including an instruction for displaying a social media application at the second client machine, the social media application facilitating the exchange of user-generated content related to the selected media content item.

18. The one or more computer readable media recited in claim 17, wherein the social media application facilitates interaction with a social media service, and wherein the second client machine is associated with a social media service user account for interacting with the social media service.

19. The one or more computer readable media recited in claim 17, wherein the social media application is operable to present, at the second client machine, an indication of one or more web pages related to the selected media content item.

20. The one or more computer readable media recited in claim 17, wherein the social media application facilitates the exchange of user-generated content via a social network selected from the group consisting of: Google Plus, Facebook, and Twitter.
